(19) United States
(12) Patent Application Publication
(10) Pub. No.: US 2020/0004843 A1
(43) Pub. Date: Jan. 2, 2020

(54) GEOCODE INTERPOLATION

(71) Applicant: Microsoft Technology Licensing, LLC, Redmond, WA (US)

(72) Inventors: Kumarswamy P. VALEGEREPURA, Bellevue, WA (US); Kartik KUKREJA, Bellevue, WA (US); Wei WU, Kirkland, WA (US); Florin TEODORESCU, Redmond, WA (US); William M. GANNON, Kenmore, WA (US); Jing LI, Sammamish, WA (US)

(73) Assignee: Microsoft Technology Licensing, LLc, Redmond, WA (US)

(21) Appl. No.: 16/022,448

(22) Filed: Jun. 28, 2018

(51) Int. Cl. G06F 17/30; G01C 21/20; G01C 21/36

(52) U.S. Cl. CPC G06F 17/30241; G01C 21/3605; G01C 21/20; G06F 17/3087

(57) ABSTRACT

The present concepts relate to interpolating a location of an address. In one example, an address index may be generated, which contains rooftop addresses and corresponding percentage values representing the percentage distances along street primitives at which those rooftop addresses are located based on rooftop locations of the rooftop addresses. Upon receiving a query address, whose rooftop location is not known, the address index can be referenced to identify two surrounding rooftop addresses between which the query address lies, and an estimated geographical location of the query address may be calculated by interpolating between the rooftop locations of the two surrounding rooftop addresses.

### BACKGROUND

Geocoding is the computational process of transforming an address into a spatial location, such as a geographical location or a geocode represented using a latitude and longitude coordinate. The geographical location of an address is commonly referred to as a rooftop location as it provides rooftop-level accurate location information. A geocoder can be a form of a search engine for maps. A geocoder may accept a user's query of an address and return a geographical location.

Address data providers may provide large databases of address information, which may contain postal addresses along with their corresponding rooftop locations (i.e., latitude and longitude coordinates). Therefore, the known postal addresses in the address data, for which rooftop locations are also known, may be called rooftop addresses. Using the address data, geocoding an address can be a simple and straight-forward process. For example, when a user queries a postal address (such as, 123 Main Street, Seattle, Wash. 98101), the postal address can be looked up in the address data, and the corresponding geographical location (e.g., 47.600065, −122.333517) can be returned. However, conventional geocoders have shortcomings, including the inability to geocode a postal address that is not included in the address data and the provision of an inaccurately estimated geographical location for such a postal address based on poor interpolation techniques, described more in detail below.

### BRIEF DESCRIPTION OF THE DRAWINGS

The accompanying drawings illustrate implementations of the concepts conveyed in this disclosure. Features of the illustrated implementations can be more readily understood by reference to the following description in conjunction with the accompanying drawings. Like reference numbers in the various drawings are used where feasible to indicate like elements. In some cases, parentheticals are utilized after a reference number to distinguish like elements. Use of the reference number without the associated parenthetical is generic to the element.

FIG. 1 shows a representative view of the types of information provided in map data that may be used with some implementations of the present concepts.

FIG. 2 shows a representative view of rooftop addresses from address data that have been assigned to rooftop locations in map data, consistent with some implementations of the present concepts.

FIG. 3 shows a representative view of several rooftop addresses plotted along a street primitive, in accordance with some implementations of the present concepts.

FIG. 4 shows a flow chart of an example address indexing method that can implement some of the present concepts.

FIG. 5 shows a flow chart of an example geocode interpolating method that can implement some of the present concepts.

FIG. 6 shows an example system for implementing the present geocode interpolation concepts.

### DETAILED DESCRIPTION

The described technology relates to processes for geocoding addresses using improved interpolation techniques. While databases of address information may be available from providers, they are often incomplete. The address data contains holes or gaps in address information. Furthermore, address data cannot stay up-to-date in real time with new properties and new constructions. Accordingly, there is a significant number of postal addresses that are not found in the address data. Therefore, trying to geocode such postal addresses can be problematic. When a user searches for such postal addresses that are not found in the address data, conventional techniques may provide an error message indicating that the queried address does not exist and/or that a geographical location of the queried address cannot be determined. Certain conventional geocoders simply cannot process requests for such postal addresses, producing results that are unsatisfactory for the user who knows that the queried address does in fact exist and who wishes to know the geographical location of the queried address.

Some conventional systems have attempted to compensate for the gaps in address data by using limited address interpolation techniques to calculate an estimated geographical location of a queried address that is missing from the address data by using information in map data. Map data providers provide maps that contain, among other things, street names, street geometry, and street number ranges for various street segments. For example, map data may provide information such as: Main Street in Seattle, Wash. has street numbers ranging from 100 to 199 from First Avenue to Second Avenue. Using conventional interpolation techniques, if a user searches for an address (such as, 175 Main Street, Seattle, Wash. 98101) that is not found in the address data, conventional systems use map data to simply interpolate an estimated geographical location for 175 Main Street to be at 75% distance along Main Street from First Avenue to Second Avenue.

Such conventional interpolation techniques have several drawbacks, resulting in unsatisfactory experience for users. Map data often does not provide street number ranges for many street segments or for entire streets, making the above-described conventional interpolation techniques impossible. In such a scenario, the result provided by a geocoder is a long stretch of a street, rather than a location point on the street, which is often not precise enough for user satisfaction. Moreover, street numbers in real life are rarely distributed evenly and linearly along a street. Often, a large range of street numbers is concentrated in a short street segment, while a small range of street numbers is widely dispersed along a long street segment. Therefore, the conventional interpolation techniques (such as, estimating 175 Main Street to be located at 75% along the street segment ranging from street numbers 100 to 199) often result in interpolation errors that output incorrect estimated geographical locations. Since conventional interpolation techniques incorrectly assume that street numbers are linearly distributed when, in fact, that is rarely the case in reality, conventional techniques are prone to producing geographical locations that are far off from the actual locations. Estimated geographical locations that are off by even 50 or 100 feet may be very unsatisfactory and frustrating for users. Interpolation errors are further exacerbated where the street segment and the street number range are very long (e.g., a mile-long stretch of a road with street numbers ranging from 1 to 15,000), resulting in unsatisfactory user experience.

Furthermore, conventional interpolation techniques are susceptible to imperfect address data. There are many cases where street numbers are situated out of sequence. And sometimes, even and odd street numbers are situated on unexpected sides of the street. These discrepancies further complicate conventional interpolation techniques and cause more errors.

Accordingly, the present concepts provide technical solutions to at least the above-described problems with conventional geocoding technologies. The present concepts relate to using information from both map data and address data to provide a larger coverage of searchable addresses and to interpolate more accurate estimated geographical locations of addresses that are not found in the address data. Moreover, the present concepts enable interpolation even where street number ranges are missing from the map data. Additionally, the present concepts are able to identify and filter out bad address data—such as out-of-sequence addresses, addresses in unexpected locations (e.g., addresses on the “wrong” side of the street), and addresses with extremely high or low street numbers (relative to other numbers on the street)—that can increase interpolation errors. In some implementations, the corpus of map data and address data may be pre-processed offline. For example, rooftop addresses in the address data can be assigned to specific location points on either side of their corresponding street primitives in the map data based on the rooftop locations provided in the address data. Furthermore, for those rooftop addresses in the address data, percentage values may be calculated, representing the percentage distances along the street primitives at which the rooftop addresses lie. This processing of map data and address data creates an address index of known rooftop addresses and corresponding percentage values representing their location points along street primitives.

When a user queries a postal address that is not found in the address data, two surrounding rooftop addresses can be identified in the address index. The surrounding rooftop addresses may be the two closest addresses to the queried postal address, between which the queried postal address lies, and may also lie on the same side of the street as the queried postal address. Since the exact rooftop locations of the two surrounding rooftop addresses are known from the address data, they can be used to interpolate an estimated geographical location of the queried postal address. For example, if a user queries 175 Main Street, which is not found in the address data (and thus not found in the address index), two closest addresses (e.g., 173 Main Street and 177 Main Street) on the same side of the street, between which the queried address lies, and whose rooftop locations are known, are used to interpolate an estimated geographical location of 175 Main Street.

The present concepts provide more accurate and more precise address interpolation techniques by leveraging rooftop address information in address data in addition to map data. By maintaining an address index of known rooftop addresses, the disclosed implementations allow for more accurate interpolation of query addresses not found in the address data. Specifically, because the address index can be used to identify two rooftop locations that are a shorter distance apart than the entire length of a street segment, the disclosed implementations can provide a more accurate geographical location for a query address that is not possible using conventional techniques that interpolate over a long street segment with an incorrect assumption that street numbers are evenly distributed along the street segment.

Map data may contain street entities including, for example, street names, street geometry, and street number ranges. A single street entity can have multiple street primitives. A street primitive may be an ordered collection of vectors. A street primitive can have one or more street number ranges. A street number range can include a street side tag indicating which side of the street primitive the street number range lies. A street number range can also include parity information indicating which side of the street primitive the even street numbers and the odd street numbers lie.

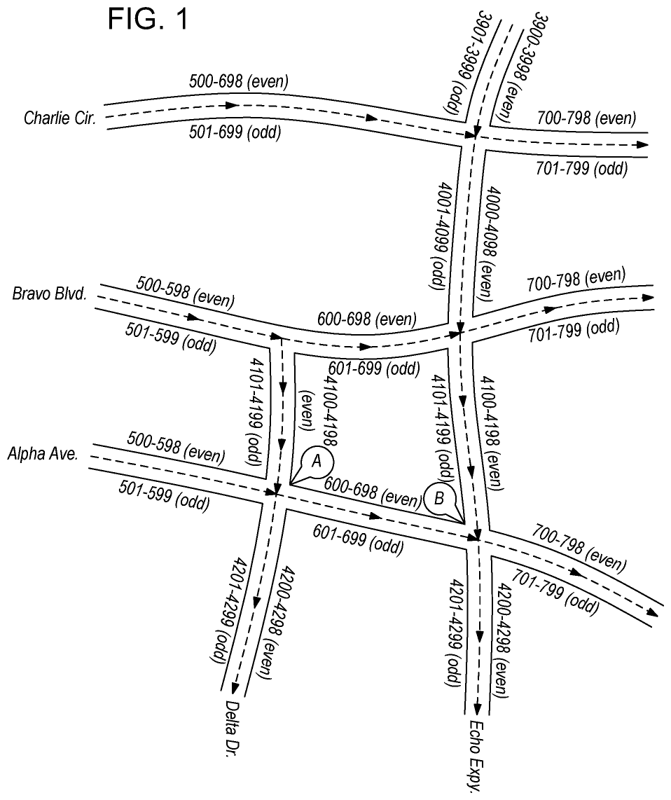

FIG. 1 depicts a visual representation of the types of information that may be provided in map data available from map data providers. In this example, FIG. 1 shows, in part, five street entities included in example map data: Alpha Avenue, Bravo Boulevard, Charlie Circle, Delta Drive, and Echo Expressway. A street entity may have multiple street primitives (or geometries). A street primitive may contain vectors. A street primitive may include one or more ranges of street numbers. For example, a street primitive may include two ranges of street numbers: an even range and an odd range for the two sides of the street. As shown in FIG. 1, the street numbers on one side of Alpha Avenue from Point A to Point B may include even numbers ranging from 600 to 698, and the street numbers on the other side of Alpha Avenue from Point A to Point B may include odd numbers ranging from 601 to 699. The map data includes not only the street names and street number ranges but also the street geometries, as illustrated in FIG. 1.

Address data providers can provide databases of known rooftop address information. Address data may include, for example, a list of postal addresses (e.g., street numbers, directions, street names, floor numbers, suite numbers, cities, states, counties, zip codes, and countries) and corresponding rooftop locations (i.e., latitude-longitude coordinate geocodes). Address data may also include business names and phone numbers along with corresponding rooftop addresses. Furthermore, address data may include building geometry or parcel geometry associated with rooftop addresses either in addition to or in lieu of rooftop locations.

The present concepts may combine map data and address data. For example, rooftop addresses in address data may be assigned to their appropriate location points in the map data. In some implementations, each rooftop address in the address data may be assigned to a location point along the corresponding street primitive in the map data based on the rooftop location (i.e., latitude-longitude coordinate) associated with the rooftop address.

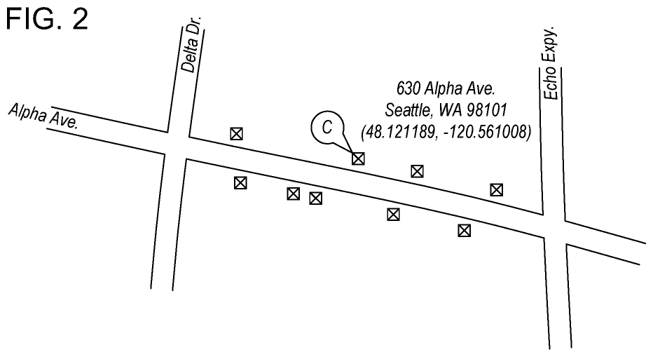

FIG. 2 depicts a visual representation of rooftop addresses in address data assigned to location points along their corresponding street primitives in the map data. For example, a rooftop address (630 Alpha Avenue, Seattle, Wash. 98101) from the address data may be assigned to Point C in the map along an Alpha Avenue street primitive based on the latitude-longitude coordinate (48.121189, −120.513008) associated with the rooftop address in the address data. This process may involve searching the map data for street entities having the same street name as a rooftop address and matching the rooftop address with the street primitive that is closest to the rooftop location of the rooftop address. Geometry operations may be performed to determine which side of the street primitive the rooftop address lies.

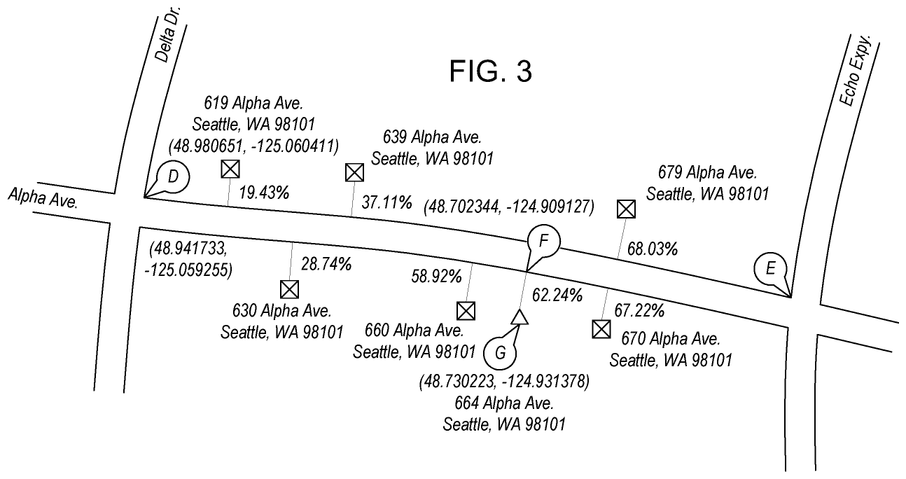

FIG. 3 shows multiple rooftop addresses from the address data plotted along their corresponding street primitive in the map data. For the rooftop addresses plotted along their corresponding streets, percentage values may be calculated, indicating the percentage distances from the start of the street primitive to the end of the street primitive at which the corresponding rooftop locations are situated. In some implementations, the lengths of the collection of vectors making up a street primitive may be summed up to calculate the percentage distances from the starting point of the street primitive to the ending point. Where a rooftop location is situated a certain offset distance away from the street primitive, a location point on the street primitive that is closest to the rooftop location may be used to calculate the percentage value. For example, the rooftop address 619 Alpha Avenue, Seattle, Wash. 98101 has an associated rooftop location of (48.980651, −125.060411). This rooftop location is offset from the street by 18 feet. Therefore, a location point on Alpha Avenue that is closest to the rooftop location may be calculated as (48.941733, −125.059255). And then, a percentage value for the calculated location point on Alpha Avenue can be determined as 19.43% distance from Point D to Point E. As another example, the rooftop address 670 Alpha Avenue, Seattle, Wash. 98101 has a corresponding location point at 67.22% distance from Point D to Point E. In some implementations, an address index storing one or more of the rooftop addresses, their geographical locations, their closest location points on the street primitives, and the corresponding percentage values may be generated and stored to be used at runtime to handle queries involving postal addresses that are not in the address data, as explained in detail below.

In some implementations, the rooftop addresses in the address index may be grouped. For example, a set of rooftop addresses along one side of a street primitive may form an address group. Another set of rooftop addresses along the other side of the street primitive may form another address group. In the example shown in FIG. 3, one address group with an odd parity may include the addresses 619 Alpha Avenue, 639 Alpha Avenue, and 679 Alpha Avenue; and another address group with an even parity may include the addresses 630 Alpha Avenue, 660 Alpha Avenue, and 670 Alpha Avenue. Forming groups of rooftop addresses within the address index may speed up searching through the address index in connection with a runtime query of an unknown postal address that is not found in the address data. The address groups may also assist in identifying outlier addresses, as explained below.

In some implementations, certain outlier addresses may be identified among the rooftop addresses in the address data (or in the address index) and excluded from the address index for improved results. One or more criteria or filters may be used to analyze the rooftop addresses in the address data to deem certain rooftop addresses as outliers that may not provide satisfactory results or user experience. For example, a rooftop address that contains no street number, an alphabetic street number rather than a numeric street number, or an absurdly large street number may be filtered and excluded from the address index. As another example, a rooftop address whose rooftop location falls outside of the sequential ordering of rooftop addresses on a street primitive based on their street numbers and percentage values may be excluded from the address index. One example approach to identifying out-of-sequence addresses may involve sorting rooftop addresses along a street primitive by their percentage values and identifying the longest increasing subsequence of street numbers along the street primitive. Then, any rooftop address on the street primitive that has a street number that is out of sequence from the longest increasing sequence may be rejected as being an outlier address or as having an incorrect latitude-longitude coordinate. Furthermore, a rooftop address whose rooftop location is in an unexpected location (e.g., lies on the wrong side of the street primitive)—based on choosing one side of the street to have even street numbers and the other side of the street to have odd street numbers in a combination that covers the largest number of rooftop addresses—may be excluded from the address index.

In some implementations, where address groups are formed in the address index, a lone rooftop address on one side of a street primitive may be deemed an outlier address and removed from the address index. In such implementations, at least two rooftop addresses on a side of a street primitive may be required to form an address group. Furthermore, a rooftop address whose street number is a certain threshold value away from the mean and/or median of all the rooftop addresses in an address group may be deemed an outlier address (perhaps having an absurdly large or very small street number) and removed from the address index. Many other filters can be applied to identify, exclude, and remove outlier addresses that are likely to result in incorrect interpolation results. The removal of outlier addresses according to the present concepts should reduce interpolation errors and thus result in improved estimates of geographical locations.

The present concepts may use the generated address index during runtime to provide an estimated geographical location of a query address whose rooftop location information is not found in the address data. For example, suppose a user or a device queries the geographical location of an address 664 Alpha Avenue, Seattle, Wash. 98101. This query address may not be found in the address data (or the address index), and therefore, its rooftop location is not known. Accordingly, the address index may be searched to find two rooftop addresses that surround the query address. In this example, as illustrated in FIG. 3, the two surrounding rooftop addresses that are closest to the query address are 660 Alpha Avenue, Seattle, Wash. 98101 and 670 Alpha Avenue, Seattle, Wash. 98101. In some implementations, the two surrounding rooftop addresses may be required to lie on the same side of the street primitive as the query address, i.e., have the same street number parity as the query address. In some implementations, the two surrounding rooftop addresses may be determined by first identifying an address group having rooftop addresses with the same street name as the query address and having a street number range within which the query address's street number falls. In certain implementations where the rooftop addresses along the street primitive have been sorted by their street numbers and/or their percentage values, the act of identifying the two closest surrounding rooftop addresses may involve performing fast binary searches.

Having identified the two surrounding rooftop addresses, their corresponding percentage values (i.e., 58.92% for 660 Alpha Avenue and 67.22% for 670 Alpha Avenue) stored in the address index may be used to interpolate a location point on Alpha Avenue for the query address 664 Alpha Avenue. In this example, a mathematical operation using a linear regression model can be performed to interpolate a percentage value of 62.24% for the query address. The present interpolation techniques can allow computing devices to operate on street primitives for which there is no street number range provided. In other words, the present implementations can improve the function of a computing system by enabling the computing system to estimate geographical locations for addresses that conventional geocoding systems cannot. Therefore, the present concepts represent significant improvements in computer system functionality over conventional geocoding systems.

Alternative to the linear regression model mentioned in the above example, other regression models may be used to interpolate a location point for the query address. For example, a best-fit regression model (whether it be polynomial, exponential, logarithmic, sinusoidal, etc.) may be determined based on the location points (or percentage values) of two or more rooftop addresses on the street primitive near the query address (whether those rooftop addresses surround the query address or lie entirely in one direction from the query address), and that regression model may be used to interpolate a location point for the query address.

In certain implementations where building geometry or parcel geometry for the surrounding rooftop addresses are available, such that the surrounding rooftop addresses take up certain widths along the street primitive, as opposed to taking up only location points, those widths may be taken into account when interpolating the location point of the query address. This technique further improves interpolation results, because the street segment over which the interpolation computation is performed excludes the building or parcel widths that are taken up by the two surrounding rooftop addresses such that the correct geographical location of the query address cannot be located over those building or parcel widths.

In some implementations, the estimated geographical location for the query address may be an interpolated location point on the street primitive. In this instance, Point F at (48.702344, −124.909127) shown in FIG. 3 may be returned as the estimated geographical location corresponding to the query address 664 Alpha Avenue, Seattle, Wash. 98101. In alternative implementations, an offset distance may be estimated for the query address based on the offset distances of the two surrounding rooftop addresses. For example, if the rooftop location of 660 Alpha Avenue is offset from the street primitive by 14 feet and the rooftop location of 670 Alpha Avenue is offset from the street primitive by 22 feet, then an average of the two offsets may be calculated as an estimated offset of 18 feet for the query address. This estimated offset may be applied to Point F to calculate Point G at (48.730223, −124.931378) to derive the estimated geographical location of the query address, as shown in FIG. 3. This is just one example of a technique for calculating an estimated offset. Various other techniques may be employed, including using a linear regression model to interpolate an offset for the query address between the two offsets associated with the two surrounding rooftop addresses based on the street numbers. Accordingly, the geocode of Point G, which has been offset from the street primitive, may be returned as the estimated geographical location of the query address. Estimated geographical locations that have been offset from the street according to the present concepts may be more accurate than those output by conventional geocoders, which are placed directly on the street.

Estimated geographical locations calculated according to the present concepts are more accurate than those provided by conventional geocoding systems that interpolate over long street segments and therefore have higher interpolation errors. Thus, the present concepts improve the functionality of computers that perform geocoding. Stated another way, geocoding results have been less than satisfactory to the user because of data scarcity (e.g., incomplete address data with missing rooftop addresses and rooftop locations). The present implementations offer the technical solution of calculating improved geocoding results with the existing scarce data. Accordingly, the described implementations provide a variety of technical advantages, including but not limited to, reduced error rate in geocoding systems, and improved user efficiency and interaction performance with applications and services providing geocoding results.

In some implementations, the estimated geographical location along with the corresponding query address may be cached and/or added to the address index for faster processing of future queries involving the same query address. Such addresses may be tagged in the address index to distinguish them from rooftop addresses with rooftop locations in the address index that were derived from the address data.

In alternative implementations, the two surrounding rooftop addresses identified may lie on opposite sides of the street primitive. In such implementations, the acts of calculating location points on the street primitive closest to the rooftop locations of the two surrounding rooftop addresses and interpolating between the two location points to calculate a location point for the query address can remain the same as described above. However, the parity of the street number in the query address may be compared with the parities of the street numbers in the two surrounding rooftop addresses to determine which side of the street primitive the query address should lie. An offset can be calculated for the query address based on the offset of one of the two surrounding rooftop addresses that has the same street number parity as the query address.

In alternative implementations, an estimated geographical location for the query address may be interpolated between the rooftop locations of the two surrounding rooftop addresses using mathematical operations based on the latitude-longitude coordinates of the two surrounding rooftop addresses, their street numbers, and the street number of the query address, without involving the percentage values. Indeed, there are many possible ways to interpolate an estimated geographical location for the query address between two surrounding rooftop addresses. The described techniques involving calculating percentage values for the rooftop addresses should be viewed as non-limiting, illustrative examples.

The present concepts may involve building an address index of rooftop addresses with known geographical locations. The address index may include the rooftop addresses from the address data. The address index may also include the percentage values calculated for the rooftop addresses. The address index can be stored for future reference at runtime.

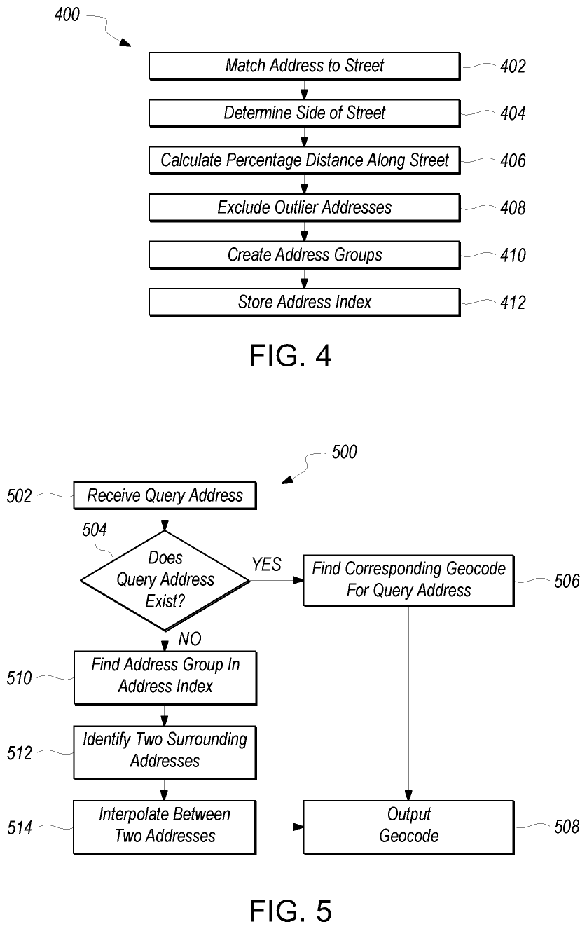

FIG. 4 shows a flow chart of an address indexing method 400. In some implementations, method 400, in part or in whole, may be performed offline as pre-processing of address data and map data to generate an address index before a particular address query is requested at runtime. Offline pre-processing may take advantage of computing resources that are available during non-peak times and may allow address queries to be answered faster and thereby enhance user satisfaction. In alternative implementations, method 400 may be performed during runtime, i.e., on-the-fly, after an address query is received.

In block 402, rooftop addresses in address data with known rooftop locations can be matched with corresponding street primitives in map data. In block 404, which sides of the corresponding street primitives the rooftop addresses lie may be determined using geometry operations based on the rooftop locations of the rooftop addresses. In block 406, percentage values for the rooftop addresses may be calculated. A percentage value may represent the percentage distance from the start of the street primitive to the end of the street primitive at which the corresponding rooftop address is located. Where a rooftop address is located a certain offset distance away from the corresponding street primitive, the point on the street primitive that is closest to the rooftop location of the rooftop address may be used to calculate the percentage value. In block 408, the rooftop addresses may be analyzed to determine whether they are outliers, and if so, they may be excluded from the address index. In block 410, address groups of rooftop addresses in the address index may be formed. Block 408 may be performed before, after, or concurrently with blocks 402, 404, 406, and 410. For example, if a rooftop address in the address data does not contain a numerical street number, it may be deemed an outlier (as in block 408) and therefore avoid the act of matching the rooftop address to a corresponding street primitive (as in block 402). Such early identification of outlier addresses can avoid unnecessarily expending computing resources and shorten the time required to perform method 400. In block 412, the address index may be stored, such as for use at runtime. The address index may be stored on the local device that would be receiving the query address during runtime. Alternatively, the address index may be stored remotely, for example, on a server or in a cloud storage, such that the address index would be accessible by a device that would receive the query address during runtime.

FIG. 5 shows a flow chart of a geocode interpolating method 500. In some implementations, method 500 may be performed at runtime, upon receiving an address whose geographical location is not already known, to interpolate an estimated geographical location for the address. In block 502, a query address may be received. For example, a user may input a postal address on a client device using an application or a browser to query the geographical location of the postal address. The query may be in the context of a user searching for a house address, a business location, or navigation directions. In some implementations, the query address may be received from a computer either locally or remotely.

In block 504, the address data and/or the address index may be searched to check for the existence of a rooftop address that matches the query address. In some implementations, the text and/or fields in the query address may be standardized or normalized (for example, using the post office's convention) when searching for a matching rooftop address. If the query address exists, in block 506, the geocode or rooftop location (represented as a latitude-longitude coordinate) for the query address stored in the address data and/or the address index may be retrieved. In block 508, the geocode corresponding to the query address can be output to the user or device that requested the location information.

Alternatively, in block 504, if the query address does not exist in the address data or the address index (or even if the query address exists but no corresponding location information is available), in block 510, an address group that corresponds to the query address may be found in the address index. The address group may contain rooftop addresses having the same street name as the query address. The rooftop addresses in the address group may contain a range of street numbers within which the street number in the query address falls. The address group may contain rooftop addresses having street numbers whose parity matches the parity of the street number in the query address.

In block 512, two rooftop addresses in the address index that surround the query address may be identified. The two surrounding rooftop addresses may be identified from within the address group found in block 510. In some implementations, the two surrounding rooftop addresses may lie on either side of the query address, may be situated on the same side of the street primitive as the query address (i.e., have the same street number parity as the query address), and may be the two closest rooftop addresses to the query address among the rooftop addresses in the address group.

In block 514, an estimated geographical location for the query address may be interpolated between the rooftop locations associated with the two surrounding rooftop addresses. Then, the estimated geographical location for the query address, which may be represented as a latitude-longitude coordinate, may be output in block 508. Because method 500 uses two rooftop addresses that surround the query address to perform an interpolation calculation to derive the estimated geographical location, the result is much more likely to be accurate compared to conventional interpolation techniques that interpolate over the entire length of the street primitive. Whereas conventional geocoding systems use only the information from map data (e.g., street geometry and street number ranges) to perform interpolations, the present concepts also use information from readily available address data (e.g., the rooftop locations of surrounding addresses) to perform improved interpolations and provide better results.

The described methods, including address indexing method 400 and geocode interpolating method 500, can be performed by the systems and/or elements described above and/or below, and/or by other devices and/or systems. The methods, in part or in whole, can be implemented on many different types of devices, for example, by one or more servers; one or more client devices, such as a laptop, tablet, or smartphone; or combinations of servers and client devices. For instance, in one case, a user, such as an automobile driver, may have an app that runs on a device (e.g., a smartphone or a car navigation system). The app may allow the user to input an address and, in turn, provide a geographical location for the user to view and/or navigate to. The order in which the methods are described is not intended to be construed as a limitation, and any number of the described acts can be combined in any order to implement the method, or an alternate method. Furthermore, the method can be implemented in any suitable hardware, software, firmware, or combination thereof, such that a device can implement the method. In one case, the method may be stored on one or more computer-readable storage media as a set of instructions (e.g., computer-readable instructions or computer-executable instructions) such that execution by a processor of a computing device causes the computing device to perform the method.

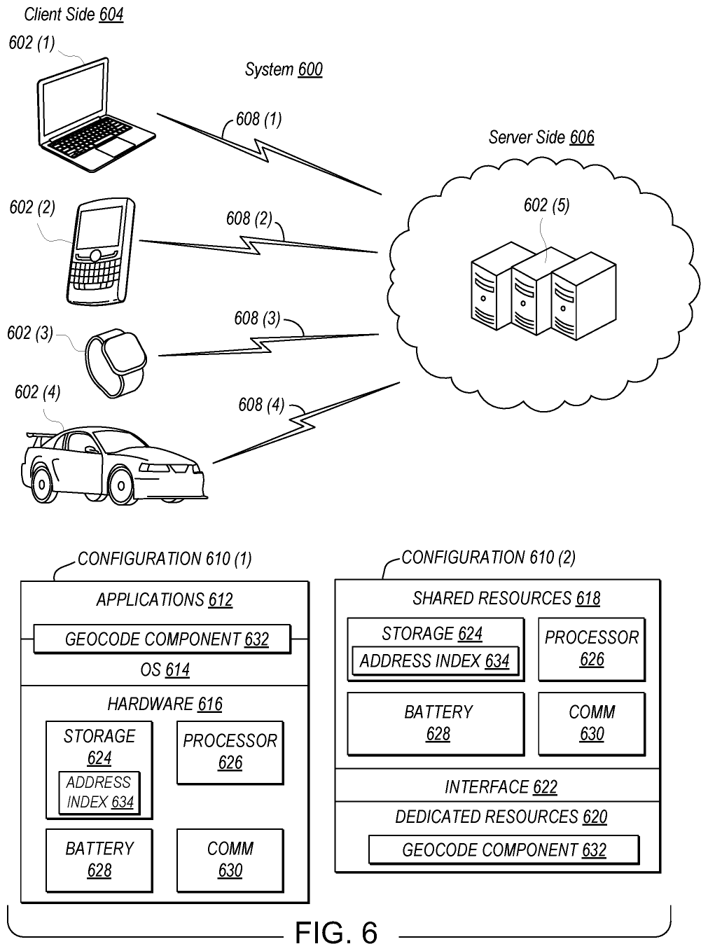

FIG. 6 shows a system 600 that can accomplish geocode interpolation concepts. For purposes of explanation, system 600 includes devices 602(1), 602(2), 602(3), 602(4), and 602(5). In this example, device 602(1) may be a laptop computer, device 602(2) may be a smartphone device, device 602(3) may be a wearable smart device, device 602(4) may be a vehicle navigation system, and device 602(5) may be a server device. For purposes of explanation, devices 602(1)-602(4) can be viewed as being client-side or user-side devices 604, and device 602(5) can be viewed as being a server-side or cloud-based resource 606. The number of devices and the client-server side of devices described and depicted are intended to be illustrative and non-limiting. Devices 602 can communicate via one or more networks (represented by lightning bolts 608(1)-608(4)) and/or can access the Internet over the networks.

Each device 602 may perform method 400 and method 500 as a standalone device. For example, a vehicle in-dash navigation system or a handheld GPS unit may perform both methods 400 and 500, and store an address index locally. Such devices stand to benefit greatly from the present concepts that provide accurate estimated geographical locations for addresses that are not found in address data, as these devices receive less frequent map data updates and address data updates compared to smartphones or laptops that frequently connect to the internet. Alternatively, any or all of the acts in method 400 and/or method 500 may be distributed among a plurality of devices 602. For example, method 400 may be performed by server 602(5) and the address index may be stored in server 602(5), while some or all of the acts of method 500 may be performed by client-side devices 604. One or more devices 602 may perform various combinations of acts in methods 400 and 500, depending on, for example, the processing and storage resources of the devices 602, as well as the communication capabilities among the devices 602. The specific examples of described implementations should not be viewed as limiting the present concepts.

FIG. 6 shows two device configurations 610(1) and 610(2) that can be employed by any or all of devices 602. Individual devices 602 can employ either of configurations 610(1) or 610(2), or an alternate configuration. One instance of each configuration 610 is illustrated in FIG. 6. Briefly, device configuration 610(1) may represent an operating system (OS) centric configuration. Configuration 610(2) may represent a system on a chip (SOC) configuration. Configuration 610(1) can be organized into one or more applications 612, operating system 614, and hardware 616. Configuration 610(2) may be organized into shared resources 618, dedicated resources 620, and an interface 622 there between.

In either configuration 610, the device 602 can include storage/memory 624, a processor 626, a battery (or other power source) 628, and/or a communication component 630. The device 602 can also include a geocode component 632. The geocode component 632 can include and/or access an address index 634 in storage 624 of the local device or in a remotely accessible device. In some cases, the geocode component 632 can be part of, or work cooperatively with, a geocoder entity/service, such as a navigation app, a map app, or an address/business directory app that can exist on a client device and/or on the cloud-based resources 606. The geocode component 632 may coordinate these aspects to return geographical locations of queried addresses despite incomplete data associated with the queried address.

In some configurations, each of devices 602 can have an instance of the geocode component 632. However, the functionalities that can be performed by individual geocode component 632 may be the same or they may be different from one another. For instance, in some cases, each device's geocode component 632 can be robust and provide all functionality described above and below (e.g., a device-centric implementation). In other cases, some devices can employ a less robust instance of the geocode component 632 that relies on some functionality to be performed remotely (e.g., an app-centric implementation that relies on remote (e.g., cloud) processing). For example, the described functionalities may be distributed among two or more devices 602 and may be distributed among client devices 604 and servers 606.

The term “device,” “computer,” or “computing device” as used herein can mean any type of device that has some amount of processing capability and/or storage capability. Processing capability can be provided by one or more processors that can execute data in the form of computer-readable instructions to provide a functionality. Data, such as computer-readable instructions and/or user-related data, can be stored on storage, such as storage that can be internal or external to the device. The storage can include any one or more of volatile or non-volatile memory, hard drives, flash storage devices, and/or optical storage devices (e.g., CDs, DVDs etc.), remote storage (e.g., cloud-based storage), among others. As used herein, the term “computer-readable media” can include transitory propagating signals. In contrast, the term “computer-readable storage media” excludes transitory propagating signals. Computer-readable storage media include “computer-readable storage devices.” Examples of computer-readable storage devices include volatile storage media, such as RAM, and non-volatile storage media, such as hard drives, optical discs, and flash memory, among others.

Examples of devices 602 can include traditional computing devices, such as personal computers, desktop computers, servers, notebook computers, cell phones, smart phones, personal digital assistants, pad type computers, mobile computers, cameras, appliances, smart devices, IoT devices, vehicles, etc., and/or any of a myriad of ever-evolving or yet to be developed types of computing devices.

As mentioned above, configuration 610(2) can be thought of as a system on a chip (SOC) type design. In such a case, functionality provided by the device can be integrated on a single SOC or multiple coupled SOCs. One or more processors 626 can be configured to coordinate with shared resources 618, such as memory/storage 624, etc., and/or one or more dedicated resources 620, such as hardware blocks configured to perform certain specific functionality. Thus, the term “processor” as used herein can also refer to central processing units (CPUs), graphical processing units (GPUs), controllers, microcontrollers, processor cores, or other types of processing devices.

Generally, any of the functions described herein can be implemented using software, firmware, hardware (e.g., fixed-logic circuitry), or a combination of these implementations. The term “component” as used herein generally represents software, firmware, hardware, whole devices or networks, or a combination thereof. In the case of a software implementation, for instance, these may represent program code that performs specified tasks when executed on a processor (e.g., CPU or CPUs). The program code can be stored in one or more computer-readable memory devices, such as computer-readable storage media. The features and techniques of the component are platform-independent, meaning that they may be implemented on a variety of commercial computing platforms having a variety of processing configurations.

Various device examples are described above. Additional examples are described below. One example includes a method comprising receiving a query address, upon determining that the query address is not found in the address index, identifying a first rooftop address and a second rooftop address in the address index between which the query address lies, and calculating an estimated location for the query address by interpolating between a first rooftop location associated with the first rooftop address and a second rooftop location associated with the second rooftop address.

Another example can include any of the above and/or below examples where the method further comprises matching rooftop addresses from address data to corresponding street primitives in map data and assigning the rooftop addresses to location points in the map data along the corresponding street primitives.

Another example can include any of the above and/or below examples where the method further comprises determining which sides of the corresponding street primitives the rooftop addresses are situated.

Another example can include any of the above and/or below examples where the method further comprises calculating, for the rooftop addresses in the address data, percentage values indicating percentage distances along the corresponding street primitives at which the assigned location points are situated.

Another example can include any of the above and/or below examples where the method further comprises generating the address index having the rooftop addresses and the percentage values.

Another example can include any of the above and/or below examples where the method further comprises grouping the rooftop addresses in the address index based at least on the corresponding street primitives and the sides of the corresponding street primitives on which the rooftop addresses are situated.

Another example can include any of the above and/or below examples where the method further comprises excluding one or more outlier addresses in the address data from the address index.

Another example can include any of the above and/or below examples where the query address is a postal address including one or more of: street number, street direction, street name, city, state, zip code, and country.

Another example can include any of the above and/or below examples where the estimated location for the query address is a geographical location represented as a latitude-longitude coordinate.

Another example can include any of the above and/or below examples where the identifying of the first rooftop address and the second rooftop address in the address index includes identifying an address group of rooftop addresses in the address index having the same street name and the same parity of street numbers as the query address.

Another example can include any of the above and/or below examples where the interpolating uses linear regression between the first rooftop location and the second rooftop location along a street primitive associated with the first rooftop address and the second rooftop address based at least on a first street number in the first rooftop address, a second street number in the second rooftop address, and a query street number in the query address.

Another example can include any of the above and/or below examples where the interpolating is based at least on a first percentage value stored in association with the first rooftop address and a second percentage value stored in association with the second rooftop address in the address index.

Another example includes a system comprising an address index including rooftop addresses and associated percentage values indicating percentage distances along street primitives at which the rooftop addresses are located, one or more processors, and at least one computer-readable storage medium storing computer-readable instructions which, when executed by the one or more processors, cause the one or more processors to perform receiving a query address that is not found in the address index, identifying, in the address index, a first rooftop address and a second rooftop address between which the query address is located, and calculating an estimated location for the query address based at least on interpolating between a first rooftop location associated with the first rooftop address and a second rooftop location associated with the second rooftop address.

Another example can include any of the above and/or below examples where the computer-readable instructions further cause the one or more processors to perform assigning the rooftop addresses from address data to corresponding street primitives in map data, determining which sides of the corresponding street primitives the rooftop addresses are situated, and calculating the percentage values associated with the rooftop addresses.

Another example can include any of the above and/or below examples where a first street number in the first rooftop address is lower than and closest to a query street number in the query address among street numbers included in the rooftop addresses that have the same street name and the same street number parity as the query address and a second street number in the second rooftop address is higher than and closest to the query street number among the street numbers included in the rooftop addresses that have the same street name and the same street number parity as the query address.

Another example can include any of the above and/or below examples where a query street name in the query address matches a first street name in the first rooftop address and a second street name in the second rooftop address, a parity of a query street number in the query address matches a parity of a first street number in the first rooftop address and a parity of a second street number in the second rooftop address, the first street number is lower than the query street number, and the second street number is higher than the query street number.

Another example can include any of the above and/or below examples where a first street number in the first rooftop address is closest to a query street number in the query address among street numbers that are lower than the query street number and are included in the rooftop addresses in the address index having a street name that matches a query street name in the query address and a second street number in the second rooftop address is closest to the query street number among street numbers that are higher than the query street number and included in the rooftop addresses in the address index having a street name that matches the query street name.

Another example can include any of the above and/or below examples where the interpolating uses a linear regression based at least on: a first street number in the first rooftop address, the first rooftop location, a second street number in the second rooftop address, the second rooftop location, and a query street number in the query address.

Another example can include any of the above and/or below examples where the computer-readable instructions further cause the one or more processors to perform calculating an estimated offset by which the estimated location is situated from a corresponding street primitive based at least on a first offset by which the first rooftop location is situated from the corresponding street primitive and a second offset by which the second rooftop location is situated from the corresponding street primitive.

Another example includes a system comprising an address index having rooftop addresses from address data and associated percentage values indicating percentage distances along corresponding street primitives at which the rooftop addresses are located and a geocode component for: receiving a query address that does not have an associated percentage value stored in the address index, identifying a first rooftop address and a second rooftop address in the address index, the first rooftop address and the second rooftop address having the same street name and the same street number parity as the query address, the first rooftop address having a first street number that is lower than a query street number in the query address, the second rooftop address having a second street number that is higher than the query street number, and calculating an estimated location for the query address by interpolating based at least on a first percentage value associated with the first rooftop address, the first street number, a second percentage value associated with the second rooftop address, the second street number, and the query street number.

1. A method, comprising:
receiving a query address;
determining whether the query address is found in an address index;
upon determining that the query address is not found in the address index, identifying a first rooftop address and a second rooftop address in the address index between which the query address lies; and
calculating an estimated location for the query address by interpolating between a first rooftop location associated with the first rooftop address and a second rooftop location associated with the second rooftop address.

2. The method of claim 1, further comprising:
matching rooftop addresses from address data to corresponding street primitives in map data; and
assigning the rooftop addresses to location points in the map data along the corresponding street primitives.

3. The method of claim 2, further comprising:
determining which sides of the corresponding street primitives the rooftop addresses are situated.

4. The method of claim 3, further comprising:
calculating, for the rooftop addresses in the address data, percentage values indicating percentage distances along the corresponding street primitives at which the assigned location points are situated.

5. The method of claim 4, further comprising:
generating the address index having the rooftop addresses and the percentage values.

6. The method of claim 5, further comprising:
grouping the rooftop addresses in the address index based at least on the corresponding street primitives and the sides of the corresponding street primitives on which the rooftop addresses are situated.

7. The method of claim 5, further comprising:
excluding one or more outlier addresses in the address data from the address index.

8. The method of claim 1, wherein the query address is a postal address including one or more of: street number, street direction, street name, city, state, zip code, and country.

9. The method of claim 1, wherein the estimated location for the query address is a geographical location represented as a latitude-longitude coordinate.

10. The method of claim 1, wherein the identifying of the first rooftop address and the second rooftop address in the address index includes:
identifying an address group of rooftop addresses in the address index having the same street name and the same parity of street numbers as the query address.

11. The method of claim 1, wherein the interpolating uses linear regression between the first rooftop location and the second rooftop location along a street primitive associated with the first rooftop address and the second rooftop address based at least on a first street number in the first rooftop address, a second street number in the second rooftop address, and a query street number in the query address.

12. The method of claim 1, wherein the interpolating is based at least on a first percentage value stored in association with the first rooftop address and a second percentage value stored in association with the second rooftop address in the address index.

13. A system, comprising:
an address index including rooftop addresses and associated percentage values indicating percentage distances along street primitives at which the rooftop addresses are located;
one or more processors; and
at least one computer-readable storage medium storing computer readable instructions which, when executed by the one or more processors, cause the one or more processors to perform:
receiving a query address that is not found in the address index;
identifying, in the address index, a first rooftop address and a second rooftop address between which the query address is located; and
calculating an estimated location for the query address based at least on interpolating between a first rooftop location associated with the first rooftop address and a second rooftop location associated with the second rooftop address.

14. The system of claim 13, wherein the computer-readable instructions further cause the one or more processors to perform:
assigning the rooftop addresses from address data to corresponding street primitives in map data;
determining which sides of the corresponding street primitives the rooftop addresses are situated; and
calculating the percentage values associated with the rooftop addresses.

15. The system of claim 13, wherein:
a first street number in the first rooftop address is lower than and closest to a query street number in the query address among street numbers included in the rooftop addresses that have the same street name and the same street number parity as the query address; and
a second street number in the second rooftop address is higher than and closest to the query street number among the street numbers included in the rooftop addresses that have the same street name and the same street number parity as the query address.

16. The system of claim 13, wherein:
a query street name in the query address matches a first street name in the first rooftop address and a second street name in the second rooftop address;
a parity of a query street number in the query address matches a parity of a first street number in the first rooftop address and a parity of a second street number in the second rooftop address;
the first street number is lower than the query street number; and
the second street number is higher than the query street number.

17. The system of claim 13, wherein:
a first street number in the first rooftop address is closest to a query street number in the query address among street numbers that are lower than the query street number and are included in the rooftop addresses in the address index having a street name that matches a query street name in the query address; and
a second street number in the second rooftop address is closest to the query street number among street numbers that are higher than the query street number and included in the rooftop addresses in the address index having a street name that matches the query street name.

18. The system of claim 13, wherein the interpolating uses a linear regression based at least on:
a first street number in the first rooftop address;
the first rooftop location;
a second street number in the second rooftop address;
the second rooftop location; and
a query street number in the query address.

19. The system of claim 13, wherein the computer-readable instructions further cause the one or more processors to perform:
calculating an estimated offset by which the estimated location is situated from a corresponding street primitive based at least on a first offset by which the first rooftop location is situated from the corresponding street primitive and a second offset by which the second rooftop location is situated from the corresponding street primitive.

20. A system, comprising:
an address index having rooftop addresses from address data and associated percentage values indicating percentage distances along corresponding street primitives at which the rooftop addresses are located; and
a geocode component for:
receiving a query address that does not have an associated percentage value stored in the address index;
identifying a first rooftop address and a second rooftop address in the address index, the first rooftop address and the second rooftop address having the same street name and the same street number parity as the query address, the first rooftop address having a first street number that is lower than a query street number in the query address, the second rooftop address having a second street number that is higher than the query street number; and
calculating an estimated location for the query address by interpolating based at least on a first percentage value associated with the first rooftop address, the first street number, a second percentage value associated with the second rooftop address, the second street number, and the query street number.
